(19) United States
(12) Patent Application Publication
(10) Pub. No.: US 2003/0055809 A1
(43) Pub. Date: Mar. 20, 2003

(54) Methods, systems, and articles of manufacture for efficient log record access

(75) Inventor: Guruprasad Bhat, Nashua, NH (US)

Correspondence Address: Finnegan, Henderson, Farabow,, Garrett & Dunner, L.L.P., 1300 I Street, N.W., Washington, DC, 20005-3315, US

(73) Assignee: Sun Microsystems, Inc.

(21) Appl. No.: 09/953,901

(22) Filed: Sep. 18, 2001

(51) Int. Cl. G06F 7/00

(52) U.S. Cl. 707/1

(57) ABSTRACT

Methods, systems, and articles of manufacture consistent with features of the present invention configure log files with header information that allow a logging service to directly access various locations of the log file. Also, log records contained in the log file may be configured with fields that allow the logging service to directly access a log record, as well as confirm its identity. Additionally, the logging service may be configured to process various requests for log records from a client using the log record fields. The logging service may use offset fields in each log record to perform efficient traversal operations while processing the requests. Furthermore, various fields in each log record may be used by logging service to perform consistency checks to verify the configuration of each log record.

### CROSS-REFERENCE TO RELATED APPLICATIONS

This application relates to the application, Attorney Docket No. 06502.0359.00000, entitled “METHODS, SYSTEMS, AND ARTICLES OF MANUFACTURE FOR IMPLEMENTING A RUNTIME LOGGING SERVICE STORAGE INFRASTRUCTURE,” filed concurrently with the present application, owned by the assignee of this application and expressly incorporated herein by reference in its entirety.

### DESCRIPTION OF THE INVENTION

1. Field of the Invention

This invention relates to logging data in a computer system, and more particularly, to methods, systems, and articles of manufacture for efficiently accessing log records.

2. Background of the Invention

In a client/server computing system operating over a network, a client may require access to data stored at the server in order perform selected operations. For instance, a client may request access to data stored at the server to write, read, or delete information associated with an application that is executing at the client. The server performs operations to process the client's request and may return data to the client, such as in a read request, or store data in a file maintained by the server, such as in a write request. Under normal operating conditions, these operations are typically performed without incident, thus allowing the computing system to provide uninterrupted service to the application.

The service provided, however, may become interrupted during abnormal operating conditions, thus hindering the server's ability to process a client request. For example, the server may experience errors or faults that may prevent access to data. Alternatively, the client, or server, may require access to data previously processed at some previous point in time for testing, security, or system maintenance purposes. To handle these situations, computing systems may create log files that include selected information associated with various operations performed by the server and/or client during processing.

A log file typically includes a list of operations performed by the server and/or client, along with an identifier associated with the log record. The items in the list are sometimes referred to as log records. The log file may be used by the computing system to retrieve information associated with operations previously performed by the server and/or client. This retrieval may be for fault recovery purposes (such as in a rollback scenario), security purposes, (such as identifying illegal operations performed by unauthorized sources), or any other purpose that requires the computing system to gain access to previously processed operations. The computing system may use the identifiers to obtain information from the log file for the above noted purposes. Although the identifiers may be used to retrieve selected log records from the log file, the process lacks efficiency and versatility.

One reason for the inefficiency of the access techniques discussed above is that a log file typically uses an index associated with each identifier for accessing a log record. This index may include an index value for each identifier that reflects the position of a log record in the log file. Accordingly, when a request for a particular log record is received, the computing system would have to traverse the index for the identifier for the log record, read the corresponding index value assigned to the identifier, and then use the index value to locate the log record in the log file. Another reason for the inefficiency of the log file access techniques is that requests to sort entire log files (or a portion of the log file) require the entire log file to be loaded and then sorted. The above described techniques include operations that waste processing resources that may be applied to normal computing system activities.

Additionally, the versatility of the log file access techniques discussed above are limited by the configuration of the log file itself. That is, typical log files may only allow limited types of access requests, that may or may not require the loading of the entire log file. For instance, in order to obtain a plurality of log records from a log file, the computing system may have to access each log record individually, using the index values, or load the entire log file in order to sort and locate the requested records. Both of these options are an inefficient use of processing resources.

### SUMMARY OF THE INVENTION

It is therefore desirable to have a method and system that allows log files to be configured in such a manner that log records may be accessed and written efficiently.

Methods, systems and articles of manufacture consistent with features of the present invention enable a computing system to provide efficient log record access and traversal through the use of a logging service. In one configuration consistent with certain principles related to the present invention, a log file may be configured with a log file header that includes fields that allow quick and direct access to various positions in the log file, such as offsets that point to the end of the log file or to the last log record stored in the log file. Also, the log file header may include a field that defines a marker value that is unique to the log file. The marker value may be placed in every log record to allow the logging service to recognize the beginning of each log record in the log file. Additionally, each log record stored in the log file may be configured with an identifier field that may be based on a file pointer associated with the log file. The log records may also be configured with other fields used by the logging service for traversing the log file, such as a hashcode field that may be used for verification purposes, and offset fields for locating neighboring log records. The hashcode field may be a unique value associated with a log record and the offset fields may include pointers to neighboring log records.

Methods and systems consistent with features of the present invention may also allow a logging service to process a log record request using the configuration of the log file and log records. In one configuration consistent with certain principles related to the present invention, the logging service may receive a request for log records within a log file from a client. In response to the request, the logging service may return a list of log record headers that include summary information associated with each log record. A log record header may include the log record identifier, hashcode, and summary information associated with the respective log record. The client may then issue subsequent requests for specific log records based on the information included in the log record headers. Each subsequent request may designate a log record by its log record identifier and hashcode. The logging service may use the log record identifier to directly access the requested log record. Furthermore, the hashcode may be used to ensure the log record is the correct record requested by the client.

Additionally, methods, systems and articles of manufacture enable the logging service to process specific requests sing the fields incorporated within the log records. The specific requests may include a request for all log records in a log file, for a specific number of log records, and for a single log record. In one configuration consistent with certain principles related to the present invention, the logging service may sort log records based on the various fields included in the log records, such as timestamps and system entity identifiers. Furthermore, the logging service may be configured to use the log record fields to perform a reverse and/or forward traversals of the log file to locate specific log records.

Also, methods and systems consistent with features of the present invention may allow logging service to perform consistency checks on each log record using various fields defined in the log records, such as a record length field.

Additional configurations consistent with certain principles related to the present invention will be set forth in part in the description which follows, and in part will be obvious from the description, or may be learned by practice of methods, systems, and articles of manufacture consistent with features of the present invention. The configurations consistent with certain principles related to the present invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several configurations consistent with certain principles related to the present invention and together with the description, serve to explain the principles of the invention. In the drawings,

FIG. 1 illustrates an exemplary logging system environment, consistent with features and principles of the present invention;

FIG. 2 illustrates another exemplary logging system environment, consistent with features and principles of the present invention;

FIG. 3 illustrates an exemplary block diagram of a log file, consistent with features and principles of the present invention;

FIG. 4 illustrates an exemplary block diagram of a log record, consistent with features and principles of the present invention;

FIG. 5 illustrates a flowchart of an exemplary write process performed by a logging service, consistent with features and principles of the present invention;

FIG. 6 illustrates a flowchart of an exemplary log record access process performed by a logging service, consistent with features and principles of the present invention;

FIG. 7 illustrates a flowchart of an exemplary list all log record process performed by a logging service, consistent with features and principles of the present invention;

FIG. 8 illustrates a flowchart of an exemplary log record access process associated with a requested range of log records, consistent with features and principles of the present invention;

FIG. 9 illustrates an exemplary block diagram of a log file associated with a process described in FIG. 8, consistent with features and principles of the present invention; and

FIG. 10 illustrates a flowchart of an exemplary single log record access process, consistent with features and principles of the present invention.

### DETAILED DESCRIPTION

Methods, systems, and articles of manufacture consistent with features and principles of the present invention enable a logging service to configure log files such that log records may be efficiently traversed and located.

Methods, systems and articles of manufacture consistent with features of the present invention may perform the above functions by configuring a log file with a header that contains fields of information that may be used for directly accessing various positions of the log file. Furthermore, the header may include a record marker field that includes a unique value associated with the log file. The unique value may be placed in each log record contained within the log file to allow a logging service to identify the beginning of a log record. Additionally, methods, systems, and articles of manufacture, consistent with features and principles of the present invention, may also configure each log record with various fields for allowing the logging service to identify a log record and its characteristics, locate neighboring log records, and verify consistency of a log record.

In one configuration consistent with certain principles related to the present invention, each log record may contain a hashcode and record identifier that allows logging service to directly locate a log record and verify its identity. Additionally, each log record may also contain an offset field that allows the logging service to jump to the location of a previous log record in the log file, a length field that specifies the size of the log record, and identity data corresponding to computing system entities associated with the log record.

Additionally, methods, systems, and articles of manufacture consistent with features and principles of the present invention enable the logging service to process log record requests using fields contained within the log file header and the log records. In one configuration consistent with certain principles related to the present invention, a client may request to receive all log records contained in a log file. To process this request, the logging service may use the various fields in the log file header, and the log records, to sort and return the complete list of log records in the log file. Additionally, a client may specify a selected range of log records by their identifiers. Logging service may process this request using the identifiers and offset fields contained within each log record to return the appropriate log records. Furthermore, logging service may process requests for a single log record by directly accessing the log file using the log record identifier associated with the requested log record.

Methods, systems, and articles of manufacture consistent with features of the present invention may also allow the logging service to verify a request for a log record by ensuring the hashcode that is included in the request matches the value in the hashcode field defined within the requested log record. Also, logging service may ensure the location of the hashcode is proper before verifying a log record. Additionally, the hashcode fields defined in the log records may be used to perform consistency checks to ensure each log record includes valid data.

Reference will now be made in detail to the exemplary configurations consistent with certain principles related to the present invention, examples of which are illustrated in the accompanying drawings. Wherever possible, the same reference numbers will be used throughout the drawings to refer to the same or like parts.

The above-noted features and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

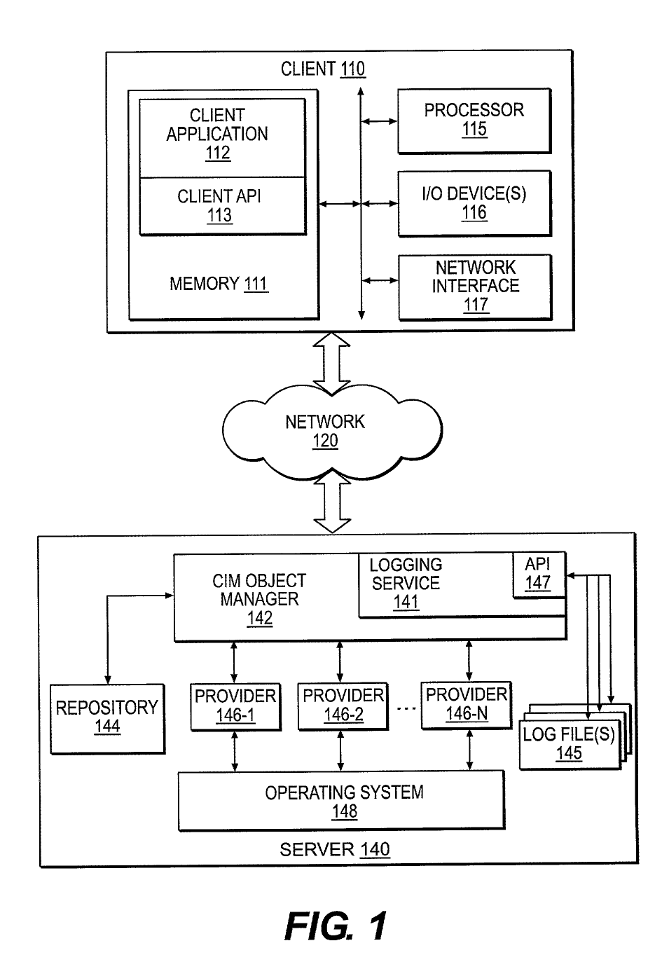

FIG. 1 illustrates an exemplary system environment in which features and principles consistent with the present invention may be implemented. As shown, FIG. 1 includes a client 110, network 120 and a server 140. Client 110 may include a desktop computer, workstation, laptop, personal digital assistant or any other similar client side system known in the art. For example, client 110 may include a processor 115, associated memory 111, and numerous other elements and functionalities available in computer systems. These elements may include input/output devices 116 such as a keyboard, mouse and display, although these input means may take other forms. Also, included in client 110 may be a network interface 117 for communicating with network 120. In one configuration consistent with certain principles related to the present invention, client 110 may be a Common Information Model (CIM) configured client. A CIM configured client may be a client that implements CIM standards and techniques to manage resources located at a resource provider, such as a server. CIM is a common data model of a schema for describing the management of information in a network environment and provides a common conceptual framework to classify and define parts of the network environment, and describe how they interact. The model is not bound to a particular implementation and enables distributed system management to take place between management systems and applications.

Memory 111 may include, among other things, data (not shown), client application 112 and client API 113. Client application 112 may be a software application configured to analyze and manage resources located in server 140. Client application 112 may manage system aspects such as, for example, disk information (space availability, partitions, etc.), CPU load, event processing, date, time, ports, etc. Client application 112 may also manage specific devices of server 140, such as disks, tape drives, modems, remote I/O devices, and network interfaces. Furthermore, client application 112 may be configured to manage software applications running on server 140 by determining what applications are currently being executed by server 140, what applications are installed, the state of these applications, which applications can be terminated, and performing user and process management. A software developer operating client 110 may use any suitable software tool to develop a management application (client application 112) for processing and displaying data from managed objected of server 140.

Client API 113 may be an application programming interface used by client application 112 to communicate with an object manager located in server 140, such as CIM Object Manager (CIMOM) 142. CIMOM 142 may be a process responsible for handling all CIM related communications between 110 client and server 140. Client API 113 may use a variety of communication protocols, including, but not limited to, Remote Procedure Call (RPC), Remote Method Invocation (RMI) and eXtensible Markup Language (XML) over a Hyper-Text Markup Language (HTTP) protocol to communicate directly with CIMOM 142.

In one configuration consistent with certain principles related to the present invention, client API 113 may represent and manipulate CIM objects. These objects may be represented as classes written in an object-oriented language such as the Java™ programming language. An object may be a computer representation or model of a managed resource of server 140, such as a printer, disk drive, and CPU. A developer uses a CIM specification to describe managed objects and retrieve information about managed objects in server 140. The CIM specification defines standards for using a CIM framework, and is defined by the Distributed Management Task Force (DMTF), which is a consortium of companies that have instituted the WBEM and CIM methodologies.

Network 120 interconnects client 110 server 140. Network 120 may include one or more communication networks, including the Internet or any other similar network that supports Web-based processing.

Server 140 may be a computer system having resources that need to be managed such as CPU load, disk space installed applications, etc. Server 140 may include a desktop computer, workstation, or any other similar server side system known in the art. Furthermore, server 140 may include, among other things a CPU, associated memory, and numerous other elements and functionalities available in computer systems (all not shown). Also, software applications may be located in the associated memory and executed by the CPU. As shown in FIG. 1, server 140 further includes a CIMOM 142, repository 144, providers 146-1 to 146-N, operating system 148, logging service 141, which further includes API 147, and log file(s) 145.

CIMOM 142 may be an object manager that manages CIM objects that may be represented as classes written in an object oriented programming language, such as the Java programming language. Client 110 running client application 112 connects to CIMOM 142, through client API 113 to obtain resource information about server 140. Once connected. client 110 receives a reference to CIMOM 142 from which client 110 may then perform WBEM operations using this reference.

CIMOM 142 communicates with either repository 144 or an appropriate provider 146-1 to 146-N, to obtain information about an object requested by client 140. CIMOM 142 may also perform other functions such as setting up communications with repository 144 and providers 146-1 to 146-N to route requests thereto, security checks, and delivering data from providers 146-1 to 146-N and repository 144 to client 110.

Repository 144 may be a central storage area for CIM classes and instance definitions. In one configuration consistent with certain principles related to the present invention, CIM classes may be stored in repository 144 as specialized objects written in an object oriented programming language, such as the Java programming language. Repository 144 may be located within server 140 or located remotely.

Providers 146-1 to 146-N may be classes that perform various functions in response to a request from CIMOM 142 and act as intermediaries between CIMOM 142 and one or more managed devices. For instance, providers 146-1 to 146-N may map information from a managed device to a CIM class written in an object oriented programming language, such as the Java programming language. For exemplary purposes, the CIM class may be referred to as a CIM Java class. Furthermore, providers 146-1 to 146-N may also map information from the CIM Java class to a managed device format. Providers 146-1 to 146-N may supply instances of a given class and support the retrieval, enumeration, modification, and deletion operations associated with managed objects. Furthermore, providers 146-1 to 146-N may supply property values associated with managed objects, such as disk space. Each provider 146-1 to 146-N may be dedicated to a particular type of operations, such as supplying dynamic property values associated with managed objects. Alternatively, providers 146-1 to 146-N may act collectively to process a request received from CIMOM 142. Server 140 may also be configured with only a single provider that handles all communications between CIMOM 142 and operating system 148.

Operating system 148 may be any operating system for the class of devices that may be used to implement server 140, such as the Solaris® operating system from Sun Microsystems, Inc.

Logging service 141 may be a process provided by CIMOM 142 that performs logging operations consistent with features and principles of the present invention. The logging operations may be associated with storing data corresponding to transactions, operations and events that occur during runtime of server 140 and its components, such as CIMOM 142. The term “runtime” may be associated with the execution of processes, applications, or services by server 140, CIMOM 142, operating system 148, and providers 146-1 to 146-N. Additionally, “runtime” may also be associated with the execution of processes, application, or services by entities other than that shown in FIG. 1, such as a CPU or controller. Furthermore, the term “runtime” may not be limited to the actual execution of a process, application, or event, but may also be associated with data transfers, transactions, idle operations, and any other state that server 140 and its components may be in after start-up and initialization.

Logging service 141 may be able to communicate directly with providers 146-1 to 146-N to perform logging operations associated with operations performed by the providers. Logging service 141 may store data associated with any event, transaction, operation, or the like, between providers 146-1 to 146-N and CIMOM 142. Furthermore, logging service 141 may be configured to perform logging operations associated with any component of server 140. For exemplary purposes, the logging operations performed by logging service 141 consistent with features of the present invention will be described with reference to providers 146-1 to 146-N; however, the description may be associated with any other component of server 140, and client 110 as well. It should also be noted that logging service 141 is not limited to being incorporated by CIMOM 142, and may be configured as a separate process in communication with CIMOM 142, or with any other management process that is implemented by server 140.

Logging service 141 may also include API 147, which acts as an interface between log file(s) 145 and logging service 141, consistent with features of the present invention. API 147 may be configured using an object oriented programming language, such as the Java programming language, however, any other programming languages may be used.

Log file(s) 145 may be one or more files used for storing data collected during logging operations performed by logging server 141. Log file(s) 145 may be located on any type of storage device that is capable of storing data, including, but not limited to, a semiconductor type memory (i.e., RAM, ROM, SRAM, DRAM, EPROM, etc.), a magnetic disk type memory, a magnetic tape type memory, and an optical disk type memory. Additionally, log file(s) 145 may stored on any combination of various types of storage devices. Log file(s) 145 may include log records that are store information associated with selected logging operations. The log records may include data associated with an operation, transaction, and/or event that logging service 141 is to manage. Log file(s) 145 may be distributed across a plurality of storage devices, or may be located within a single device. Furthermore, log file(s) 145 may be segregated into different storage devices by logging service 141 based on particular criteria, including, but not limited to, the type of logging operation performed, a type of data in a log record, and the source of a log request received by logging service 141.

Although FIG. 1 shows a single client 110, it should be noted that more than one client 110 may be in communication with server 140. Furthermore, a plurality of servers 140 may also be used with one or more clients 110 to perform functions consistent with features and principles of the present invention. Additionally, client 110 and server 140 may be located in the same computer system, with communications between the two facilitated by a communication bus or link. Also, server 140 may execute software applications and processes that perform tasks similar to that of client 110. Accordingly, these applications and processes may provide requests to CIMOM 142 associated with a managed resource as well. Furthermore, methods, systems and articles of manufacture consistent with features of the present invention are not limited to CIMOM 142 receiving requests from client 110 alone. Requests from other sources, such as components within server 140 and entities outside of server 140 may be processed by CIMOM 142.

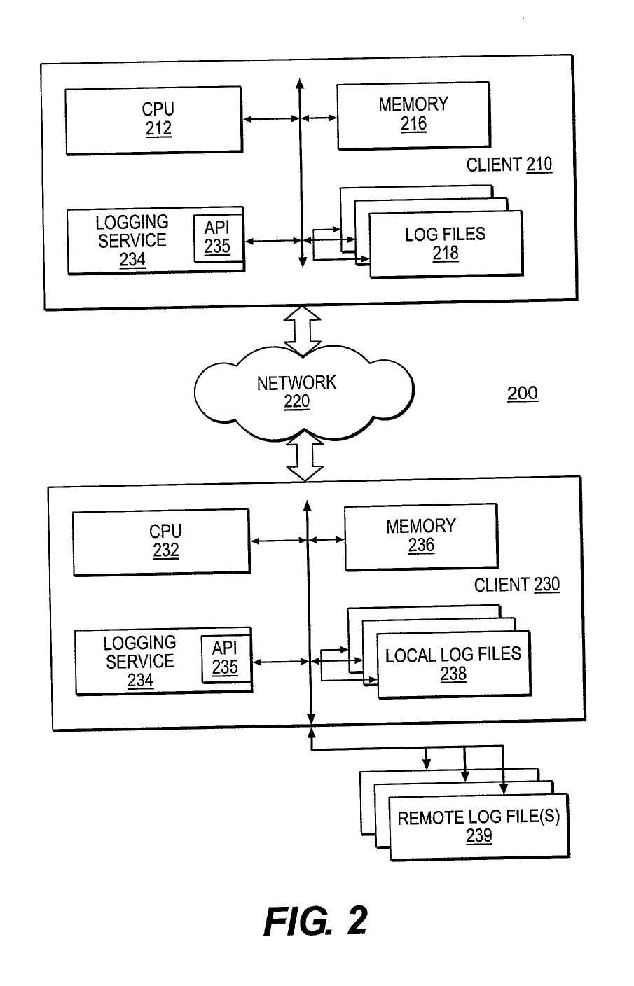

The configuration shown in FIG. 1 is not intended to be limiting, and methods, systems, and articles of manufacture consistent with features of the present invention may be used in non-CIM configured environments. FIG. 2 illustrates another exemplary system environment 200 in which methods, systems, and articles of manufacture consistent with features of the present invention may be implemented. As shown in FIG. 2, environment 200 includes a client 210, network 220 and server 230.

Client 210 may be a desktop computer, workstation, laptop, personal digital assistant or any other similar client side system known in the art. For example, client 210 may include a CPU 212, associated memory 216, and numerous other elements and functionalities available in today's computer systems. These elements may include input/output devices such as a keyboard, mouse and display, although in an accessible environment these input means may take other forms. Also, included in client 210 may be a network interface for communicating with network 220. Additionally, client 210 may also include a local logging service 234 with an API 235, and client log files 218.

Network 220 interconnects client 210 to server 230. Network 220 may include one or more communication networks, including the Internet or any other similar network that supports Web-based processing.

Server 230 may be a computer system having resources that may be used by client 210 during runtime operations of environment 200. Server 230 may include a desktop computer, workstation, or any other similar server side system known in the art. Furthermore, server 230 may include, among other things a CPU 232, associated memory 236, and numerous other elements and functionalities available in today's computer systems (not shown). Also, software applications may be located in the associated memory 236 and executed by the CPU 232. As shown in FIG. 2, server 230 may further include a logging service 234 with an API 235, and local log files 238. Server 230 may also have access to remote log files 239.

Logging service 234 and API 235 may perform logging operations consistent with features of the present invention. In one configuration consistent with certain principles related to the present invention, logging service 234 and API 235 communicate with log files 238 to perform local logging operations consistent with features and principles of the present invention. Logging service 234 and API 235, on the other hand, may perform logging operations consistent with features of the present invention for client 210 as well as server 230, and may communicate with either local log files 238, and remote log files 239, and client log files 218.

Computing systems, such as servers 140, 230 and clients 110, 210, may be implemented in environments other than a CIM configured environment that allow a logging service to perform logging operations consistent with features of the present invention. For exemplary purposes, description of systems and methods consistent with the present invention will be associated with the system environment shown in FIG. 1. However, the following description of methods, systems, and articles of manufacture consistent with features of the present invention may be employed in other configurations without departing from the scope of the invention.

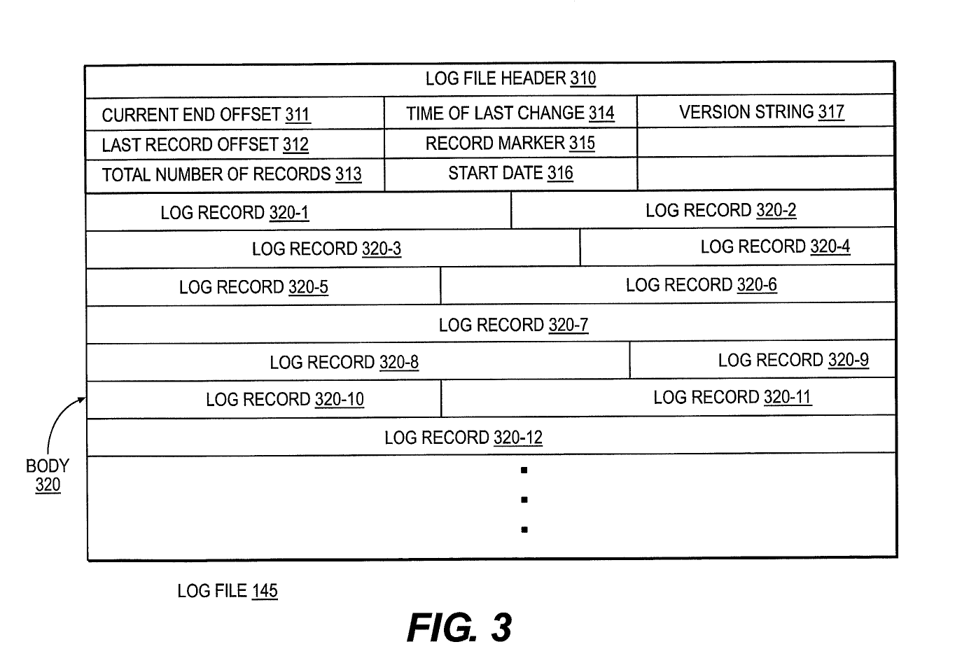

Methods, systems, and articles of manufacture consistent with features of the present invention enable a logging service to provide a log file structure that may be used to perform efficient log record traversals. FIG. 3 illustrates an exemplary log file structure consistent with one aspect of the present invention. As shown, log file 145 may be segregated into two sections, a log file header section 310 and log file body 320, which may contain log records 320-1 to 320-12. It should be noted that the number of log records included in body 320, as shown in FIG. 3, is exemplary and methods and systems consistent with the present invention may place any number of log records in body 320 without departing from the scope of the invention.

Log file header 310 may include several fields that are created and used by logging service 141 to enable logging operations to be performed consistent with features of the present invention. In one configuration consistent with certain principles related to the present invention, log file header 310 may include a current end offset field 311, a last record offset field 312, a total number of records field 313, a time of last change field 314, a record marker offset field 315, a start date field 316, and a version string field 317.

Current end offset field 311 may contain a value that reflects the current end of log file 145. This value may be used by logging service 141 to directly access the end of log file 145. Last record offset 312 may contain a value that reflects a pointer to the beginning of the last log record (or to the end of the last log record). For example, as shown in FIG. 3, last record offset field 312 may contain a value that points to the beginning of log record 320-12.

Total number of records field 313 may contain a value that reflects the current total number of log records stored in the body 320 of log file 145. For example, field 313 may include a value reflecting twelve log records currently stored in log file 145. Field 313 may be updated dynamically each time a new log record 220 is written in log file 145. Time of last change field 314 may contain a value reflecting a timestamp associated with the last update to log file 145. Accordingly, each time log file 145 is modified, a timestamp value of when the modification occurred may be placed in field 314.

Record marker field 315 may contain a set of data, such as bytes of data, that identify the beginning of a log record. The set of data may be unique to a particular log file, such as log file 145. Furthermore, each log record 320-1 to 320-12 may begin with the same unique set of data defined in record marker 315. Accordingly, record marker 315 may be used by logging service 141 to jump from one log record to another by detecting the unique set of data defined in the next log record as body 320 is traversed.

In one configuration consistent with certain principles related to the present invention, record marker 315 may be defined when log file 145 is created. Start date field 316 may contain a value reflecting when log file 145 was initially created. And, version string field 317 may contain a value reflecting a current version of log file 145. Field 317 may be used by logging service 141 to configure server 140 to allow for backward compatibilities of previous versions of log files.

Although FIG. 3 illustrates a particular configuration for the log file header 310, those skilled in the art will appreciate that other configurations may be used in accordance with the principles and features consistent with the present invention.

Body 320 of log file 145 may contain log records 320-1 to 320-12. Each log record may be associated with a transaction, operation, and/or event that occurred during runtime of server 140 of client 110. As such, each may be a different size; alternatively they also have the same size. In configurations where they have the same size it may be messages to provide functionalities for linking related log records, e.g., records related in that they are associated with the same set of events. In one configuration consistent with certain principles related to the present invention, selected fields within log records 320-1 to 320-12 may have predefined sizes, from which various values that reflect characteristics of the log record may be placed within.

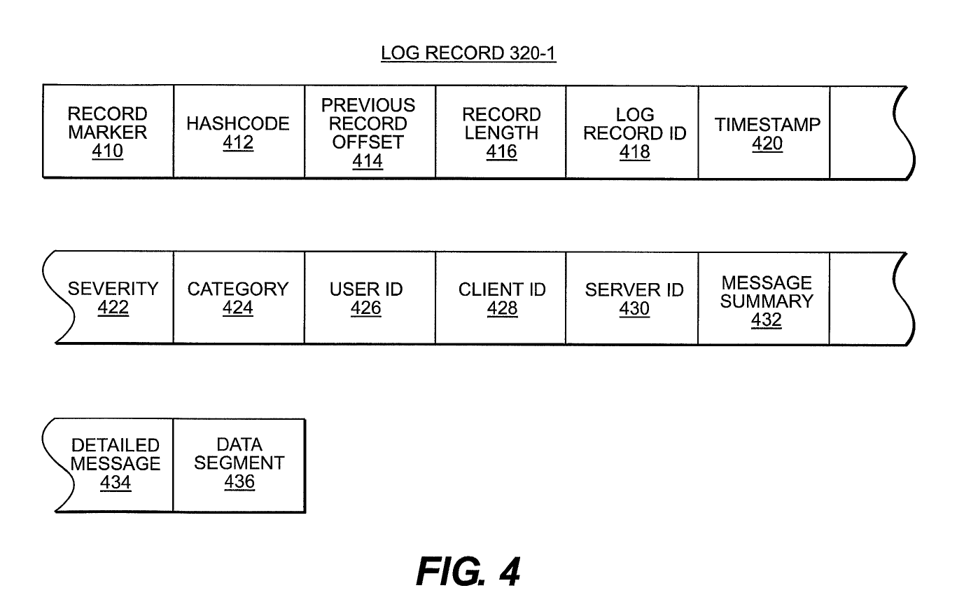

FIG. 4 illustrates an exemplary configuration of a log record (i.e., log record 320-1) in accordance with one aspect of the invention. As shown in FIG. 4, log record 320-1 may contain several fields that may be used to perform functions consistent with features of the present invention. The fields contained within log record 320-1 may include record marker 410, hashcode 412, previous record offset 414, record length 416, log record identifier (“ID”) 418, timestamp 420, severity 422, category 424, user ID 426, client ID 428, server ID 430, message summary 432, detailed message 434, and data segment 436.

Record marker 410 may contain the unique set of data defined in record marker field 315 located in the file header. Because every log record 320-1 to 320-12 may include a record marker 410, each log record may include the same unique set of data defined in record marker field 315 within their respective record marker field 410.

Hashcode 412 may contain a code that is unique to log record 320-1. Hashcode 412 may be used in conjunction with record marker 410 to ensure a request for a log record (i.e., 320-1) is from a valid source. Furthermore, hashcode 412 may be used to guard against the misidentification of record marker 410 by logging service 141 when traversing log file body 320. For example, suppose a log record includes a record marker 410 that contains a unique set of four bytes, such as “ABCD.” Further suppose that within a data segment of another log record, a byte sequence similar to the record marker (i.e., “ABCD”) is defined. Therefore, when the log record is requested by client 110, logging service 141 may detect the byte sequence defined in the data segment of the another log record and misidentify it as the beginning of the requested log record. In order to guard against this misidentification, logging service 141 may be configured to verify a requested log record by determining that the record marker “ABCD” is followed by the hashcode 412 defined for the requested log record. Since each hashcode 412 is unique to a log record, the potential of misidentifying a requested log record is greatly reduced.

Previous record offset 414 may contain a value that reflects a pointer to a previous log record in body 320. Previous record offset 414 may point to a record marker 410 of the previous log record. In one configuration consistent with certain principles related to the present invention, the previous record offset 414 of a first log record in a log file (i.e., log record 320-1) may include an invalid value.

Record length 416 may contain a value that reflects the total length of log record 320-1. This value may be determined by logging service 141 when the log record is created. Log record ID 418 may contain a value that reflects an identifier associated with log record 320-1. Each log record in log file 145 may have a unique log record ID 418, and may be used by a requesting entity (i.e., client 110) to request a specific log record. Timestamp 420 may include a value that reflects a date and/or time that log record 320-1 was created.

Severity field 422 may contain a value that reflects a type of severity associated with the log record, based on the data included in data segment 436. The types of severity may vary and may include, for example, a warning severity associated with an event and/or operation that may be of concern to servers 140, 230 and/or clients 110, 210, an error severity reflecting an event and/or operation associated with an error, failure, and/or fault condition, and a normal severity that reflects normal operations.

Category 424 may contain a value that reflects a type of category associated with the data included in log record 320-1. The types of categories may be predefined by logging service 141, and may include a security category, an application category, and a system category. A security category may be associated with log records that store data corresponding to a security event and/or operation with server 140 and/or client 110. An application category may be associated with operations and/or events of that were generated based management operations being performed by client 110 and/or server 140. For example, if client application 112 uses a management infrastructure to create a new disk partition, the entity that performed the task, such as provider 146-1 to 146-N, should generate a log record to record the event under the application category. A system category may be associated with operations and/or events corresponding to changes in low level processes, components, and/or entities that support high level process, components, and/or entities in client 110 and/or server 140. For example, an event associated with CIMOM 142 running out of memory space during normal operations may direct CIMOM 142 to create a log record under the system category.

User ID 426 may include a value that reflects an identifier associated with a user that was running a process or operation that caused log record 320-1 to be created. User ID 426 may include a username of a user who previously logged in to server 140 to perform processes and operations provided by server 140. It should be noted that the particular identifier placed in user ID 426 is not restricted to usernames, a variety of other identifiers may be used by methods and systems consistent with the present invention to identify a user and/or operator associated with a generated log record.

Client ID 428 may contain a value that reflects an identifier associated with a device that requests the services of logging service 141. For example, referring to FIG. 2, if client 210 calls logging service 234 located in server 230 (to perhaps create a log record) client ID 428 may include a client host name (i.e., machine identifier) associated with client 210. Server ID 430, on the other hand, may contain a value that reflects an identifier associated with the entity that is running the logging service that maintains the log file where log record 320-1 is located. Referring to FIG. 3, log record 320-1 is located within log file 145, thus server ID 430 may include a server host name (i.e., server machine identifier) associated with server 140. Server ID 430 may be useful in system configurations where there are distributed log files managed in servers remotely located from one another, such as in different countries or geographical regions. The system configuration may perform periodic consolidations of all distributed log files into a central repository. Therefore, the central repository would have access to the location of each log file that is consolidated for management purposes.

Message summary 432 may contain a message that briefly describes log record 320-1. Detailed message 434 may contain a more detailed message that is associated with the message stored in message summary 432. Detailed message 434 may contain the specifics of what type event and/or operation was running and what happened that caused log record 320-1 to be created. And, data segment 436 may contain conditional and/or contextual information associated with the events and/or operations described in detailed message 434. For example, if detailed message 434 contained information associated with a failed memory device, data segment 436 may include the data that was located in particular address locations of the failed memory device. Also, state values, flags values, register values, etc., associated with the components affected by the failed memory device may be stored in data segment 436. It should be noted that the information stored in fields 432-436 are not limited to the above examples. Methods and systems consistent with features of the present invention may allow any type of information to be included in these, and other, log record fields.

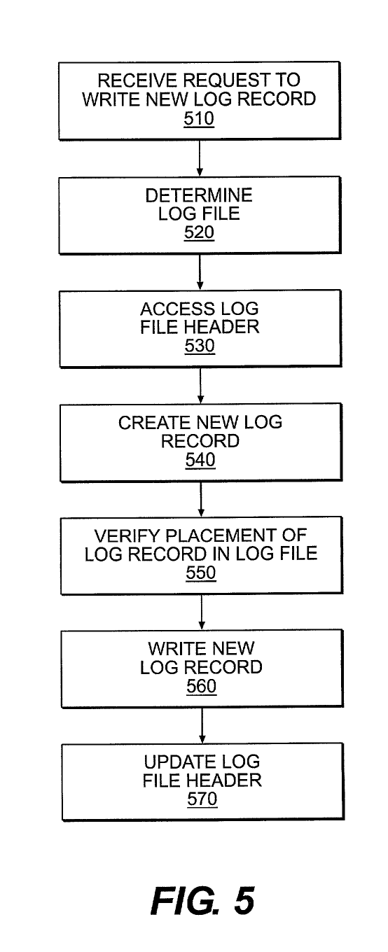

The exemplary configuration of log file 145 may be created by a logging service to provide efficient access and traversal of log records to a requesting entity, such as client 110. FIG. 5 illustrates an exemplary process that may be performed by logging service 141 and API 147 to generate a log record in log file 145 consistent with features of the present invention. As shown in FIG. 5, logging service 141 may receive a request to create a log record based from a requesting entity, such as client 110 (Step 510). The request may be based on a variety of conditions including, but not limited to, an error, a failure, a predefined event and/or operation, access to particular memory locations, exceptions, and any other condition that client 110 decides requires a log record. Furthermore, the request may originate from components other than client 110, including components internal to server 140, as well as other remotely located clients connected to network 120. The request may include all the necessary information need for logging service to create a log record consistent with features of the present invention. Alternatively, logging service 141 and client 110 may interact dynamically to allow logging service 141 to obtain additional information associated with the type of event and/or operation that occurred that invoked the request for a log record to be created.

Once the request is received, logging service 141, through API 147, determines the appropriate log file where the new log record is to be located (Step 520). The log file may be designated by client 110 in the request, or alternatively, logging service 141 may be configured to analyze the request to determine the appropriate log file. For example, a request associated with an error event may direct logging service 141 to place a log record in a log file dedicated to error log records. In one configuration consistent with certain principles related to the present invention, all log records are placed in the same log file until it has reached maximum capacity, where another log file is used to continue storing new log records. After the appropriate log file is determined, (i.e., log file 145), logging service 141 may access log file header 310 to determine the record marker 315 that needs to be used for record marker 410 associated with the new log record to be created (Step 530). Additionally, logging service 141 may also access last record offset 312 to obtain the pointer to the end of log file 145 in order to allow the new log record to be directly placed at the end of the last log record in log file 145. For example, referring to FIG. 3, a new log record that is created may be placed in a location in log file 145 that is immediately following log record 320-12 by using last record offset 312.

Once the appropriate log file header information is obtained, logging service 141 may create a new log record associated with the request (Step 540). Creating the new log record may include generating a unique hashcode for the new log record. The hashcode may be generated using a number of techniques including, but not limited to, a pseudorandom process that creates a unique signature based on data located in log record. Also, the type of severity and category value to be placed in severity and category fields 422 and 424, respectively, may be determined.

The identifiers associated with client 110 and server 140 may be used to fill fields 428 and 430, respectively. Also, user ID field 426 may be filled with an identifier associated with a user operating client 110 at the time the request was made. This may be provided in the request received from client 110, or may be obtained from server 140 that may maintain a record of users operating clients and connected to server 140, via a user log-in file or the like.

Logging service 141 may also create a unique log record identifier and place it in log record ID field 418. Log record ID 418 may be created using file pointers associated with log file 145. File pointers are typically used in files to designate a position within a file. Accordingly, methods and systems consistent with features and principles of the present invention may take advantage of this locator and generate log record IDs based on a file pointer. This way, not only is each log record associated with a unique identifier (every file pointer is unique in a log file because it points to a unique location), but also the file pointer allows logging service 141, through API 147, to locate and directly access the log record within the log file.

In creating the new log record, logging service 141 may place summary and detailed information in message summary field 432 and detailed message field 434, respectively. These message fields may be filled with information provided by client 110 in the request. Alternatively, server 140 may be configured to allow for a system administrator and/or user to create message data for fields 432 and 434. Data segment 436 may be filled with information associated with state values, memory locations, register values etc., associated with components and memory locations associated with the event and/or operation that initiated the log record to be requested. In one configuration consistent with certain principles related to the present invention, this information may be provided by client 110 in the request.

Once the relevant log record identifier and descriptive information is created and placed in the new log record, logging service 141 may then determine the total length of the log record and place a value reflecting this in record length field 416. Record length field 416 may include the length of the field 416 as well (as it may be a predefined size set by logging service 141). Logging service 141 may also create the offset value to be placed in previous offset record field 414. This may be performed using a variety of techniques including, but not limited to, using the last record offset field 312 in log record header 310 (if field 312 points to the beginning of the last log record in log file 145), or the record length field 416 of the previous log record and last record offset field 312 (if field 312 points to the end of the last log record in log file 145). Finally, logging service may generate a timestamp when the log file was created and place it in timestamp field 420.

Once the new log record is created, logging service 141 may perform verification processes to ensure the log record will fit in log file 145 (Step 550). This may be performed using a variety of techniques including, but not limited to, using current end offset 311, last record offset 312, and the record length fields 416 of both the last log record in log file 145 and the new log record. For example, logging service 141 may determine the last available location in log file 145 using current end offset field 311 in log file header 310. Also, logging service may use record length 416 of the last log record in log file 145 and last record offset 312 to determine the last location of the last log record in log file 145 (adding the length of last log record to the last record offset). Alternatively, last record offset 312 may be used if it points to the location following the last used memory location in log file 145.

Once the location of the last used memory location in log file 145 is determined, the available memory space in log file 145 may be calculated by subtracting the current end offset 311 from the maximum file size allowed by logging service 141. The result of the subtraction process may be compared to the length of the new log record to determine whether it will fit within log file 145. Other techniques may be employed by logging service 141 and the above example is merely one way that may be used to ensure a new log record can be written into a log file.

If the new log record will not fit within log file 145, logging service 141 may direct the log record to another log file (where a new record marker 410, and log record ID 418 may be generated). Alternatively, logging service 141 may return a message to client 110 indicating the inability to write to log file 145 (Step 560). On the other hand, if the new log record will fit within log file 145, logging service 141, through API 147, may write the new log record into the appropriate position within log file 145. Logging service 141 may also update log file header 310 by updating time of last change 314 to reflect the time when the new log record 320-1 was written. Furthermore, last record offset 312 and total number of records 313 fields are updated to reflect the newly added log record to log file 145 (Step 570).

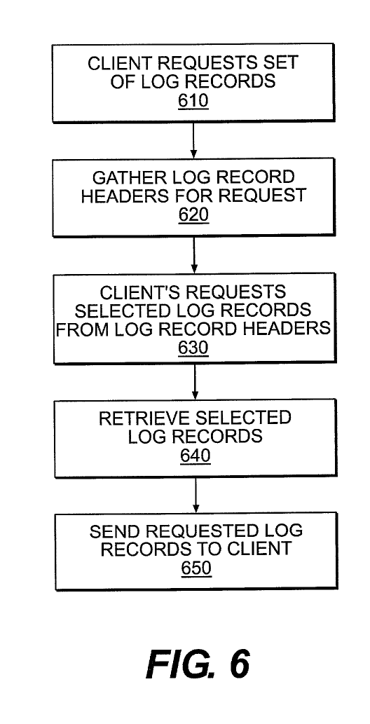

Logging service 141 creates log records such that they may be accessed efficiently. Once stored in a log file, log records may provide valuable information to a computing system for a variety of purposes, such as error and fault recovery purposes, system maintenance, management operations, and security checks. Accordingly, at some point in time, an entity, such as client 110, may wish to view one or more log records. FIG. 6 illustrates an exemplary log record request process consistent with features and principles of the present invention.

As shown in FIG. 6, client 110 may request to browse log records stored in log file 145 (Step 610). The request may designate a specific range of log records or simple be a generic request to view a log file. In response to the log file request, logging service 141 may gather log record headers associated with each log record in log file 145 and send the log record headers to client 110 (Step 620). A log record header may be a collection of designated fields within a log record that are used to provide a brief, but descriptive, indication of what each log record entails. In one configuration consistent with certain principles related to the present invention, a log record header includes hashcode 412, log record ID 418, severity 422, category 424, and message summary 432. In this manner, the amount of information transferred between client 110 and server 140 is reduced, while still providing enough description about each log record for client 110 (or an operator thereof) to review. Client 110 may then provide the set of log records to an operator where selected log records of interest may be selected. The operator may select one or more of the presented log records, and send a corresponding request to logging service 141 for the selected log record(s) (Step 630).

In one configuration consistent with certain principles related to the present invention, the request from client 110 includes the log record ID and hashcode provided in the corresponding log record header previously provided by logging service 141. Logging service 141 receives the request, and depending on the type of request (i.e., single or multiple log records) processes the request to retrieve the appropriate log records (Step 640). Each log record that is accessed and retrieved may be placed in a results file, list, packet, queue, buffer, and/or any other location that may be used to temporarily store the accessed log records.

Once any requested log records are obtained, logging service 141 may collect the stored log records that were accessed and send the them to client 110 for further processing and/or viewing (Step 650).

As shown in FIG. 6, client 110 may request one or more log records from log file 145 based on the log record headers previously provided by logging service 141. Each type of request may be handled in a variety of manners by logging service 141.

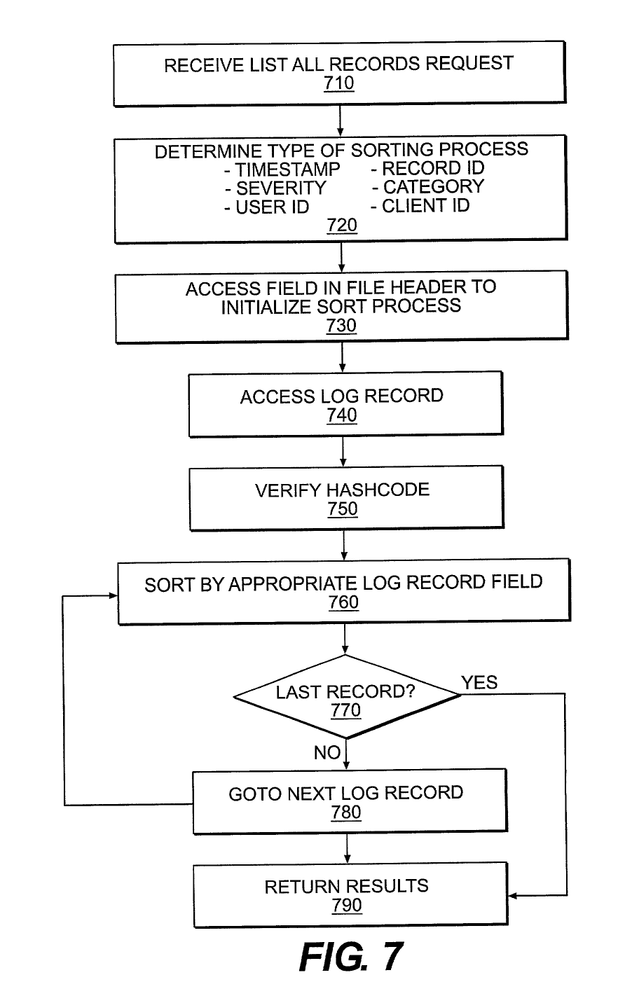

FIG. 7 illustrates an exemplary log record retrieval process for listing all log records in log file 145 consistent with features of the present invention. Logging service 141 may receive a request from client 110 to list all log records in log file 145 (Step 710). In one configuration consistent with certain principles related to the present invention, logging service 141, through API 147, may allow a log record request to designate how the log records should be returned. To handle such a request, logging process may be configured to sort the log records based on selected fields defined within each log record. Logging operations 141 determine the type of sorting process 141 to implement based on the request (Step 720). In one configuration consistent with certain principles related to the present invention, logging service 141 may sort the log records chronologically, reverse-chronologically (both based on timestamp information), by record ID, by category, by severity, by user ID, and by client ID.

Once the appropriate sorting process is determined by logging service 141, the total number of records field 313 maybe accessed to initialize the sort process (Step 730). Next, logging service 141 accesses the first log record in body 320 (Step 740). In one configuration consistent with certain principles related to the present invention, logging service 141 may optionally verify the log record accessed by checking the hashcode assigned to that particular log record (Step 750). Because the log record headers previously received by client 110 included the hashcode for each log record, the client may include the hashcode in the request for listing all of the log record in log file 145. Accordingly, log file may begin to verify the currently accessed log record by ensuring that the hashcode associated with a log record ID received in the request from client 110 follows the record marker field 410. For performance purposes, the hashcode verification process may be skipped by logging service 141. Also, the hashcode in the request may be checked by comparing its value to the value found in hashcode field 412.

Once the log record in log file 145 is accessed (and possibly verified), logging service 141 performs a sort process as designated in the request by client 110 (Step 760). For example, logging service 141 may sort the log records chronologically or reverse-chronologically using timestamp field 420. Alternatively, client 110 may designate in the request to receive only log records that have an error severity value. In this configuration, logging service 141 may use severity field 422 to sort and filter the log records, disqualifying log records that do not have a value reflecting an error in field 422. Also, the same process may be implemented to sort by category, user ID, and client ID, where logging service 141 may disqualify log records that do not meet the designated value indicated in the request from client 110.

After the accessed log record is sorted, logging service 141 may place the log record in a results file, list, packet, queue, buffer, and/or any other location that may be used to temporarily store the accessed and sorted log records. Afterwards, logging service 141 may determine whether the accessed log record is the last log record in log file 145 (Step 770). In one configuration consistent with certain principles related to the present invention, logging service 141 may track the number of accessed log records during the sort process and compare that number to total number of records field 313. Alternatively, logging service 141 may also use the last record offset field 312 to determine whether the accessed log record is the in the same position as indicated in field 312. Logging service 141 may incorporate other techniques on how to determine whether the accessed log record is the last log record in log file 145, and methods and systems consistent with features of the present invention are not limited to the above described examples.

If the accessed log record was not the last log record (Step 770; NO), logging service 141 may then access the next log record following the sorted accessed log record (Step 780), and the process may repeat at Step 750 (or Step 760). Logging service 141 may locate the next log record in log file 145 using a number of different techniques, including, but not limited to, accessing the record length field 416 of the currently accessed log record. Logging service 141 may use field 416 to index itself to the next log record from the beginning of the accessed log record. Logging service 141 may then determine whether a record marker 410 is found in the indexed location (thus verifying that a log record exists), and perhaps confirm this with a check of the hashcode assigned to the record ID associated with the next log record.

Returning to Step 770, in the event logging service 141 has accessed and sorted the last log record (Step 770; YES), the list all record process may end, and the log records that are stored in the results file may be sent to client 110 (Step 790).

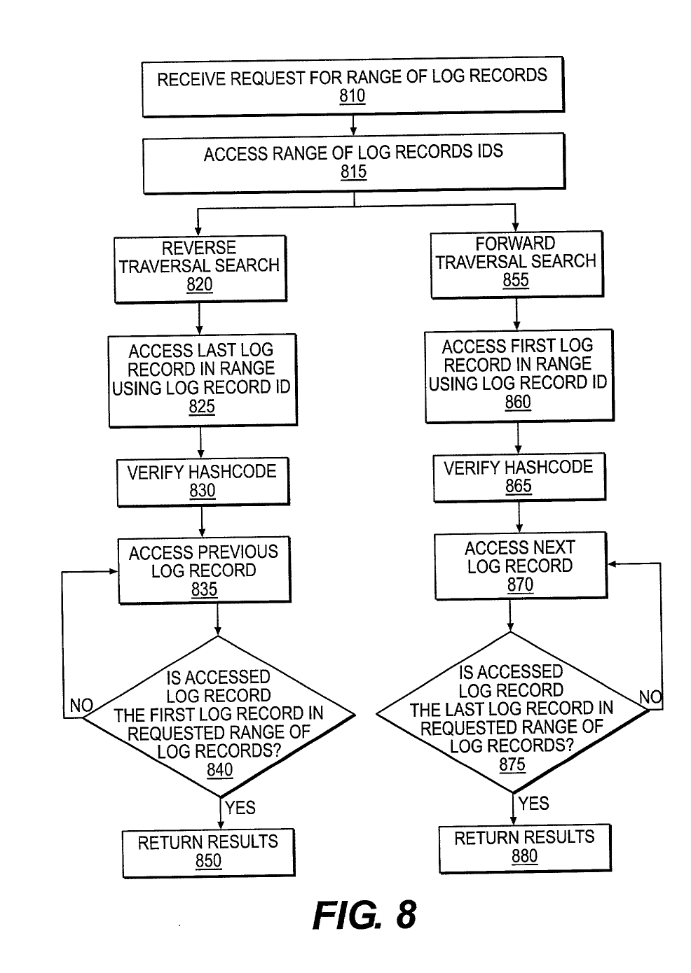

In addition to listing and sorting all log records in log file 145, logging service 141 may be configured to provide a requested range of log records. FIG. 8 illustrates an exemplary process that may be performed by logging service 141 to provide a range of log records consistent with features of the present invention. As shown in FIG. 8, logging service 141 may receive a request to list a range of log records identified by their log record ID fields 418 (Step 810). Logging service 141 obtains the range of log record IDs from the request (Step 815) and determines the type of traversal to perform, either based on the request by client 110, or by itself. In one configuration consistent with certain principles related to the present invention, logging service 141 may collect a range of log records 141 by reverse traversal or forward traversal.

If reverse traversal is selected (Step 820), logging service 141 may access the last log record identified in the range of log records using its log record ID 418 (Step 825). Because the log record field 418 was created using the file pointers associated with log file 145, logging service 141 may directly access the last log record indicated in the requested range. Accordingly, logging service 141 may avoid any extra processing to determine the location of a log record, such as accessing an index table in log file header 310. Next, logging service 141 may optionally confirm the hashcode of the accessed log record in a manner similar to that previously described for Step 750 of FIG. 7 (Step 830). Once the hashcode of the accessed log record is verified, the log record may be placed in a results file, list, packet, queue, buffer, and/or any other location that may be used to temporarily store the accessed log records.

Logging service 141 may then access the next previous log record in the range of requested log records (Step 835). In one configuration consistent with certain principles related to the present invention, the next previous log record may be accessed using the previous record offset field 414. The previous record offset field 414 allows logging service 141 to efficiently perform a reverse traversal in log file 145 without having to access an index table or recalculate the position of the next log record in the request. The previous record offset field 414 directs logging service 141 directly to the record marker 410 of the next previous log record.

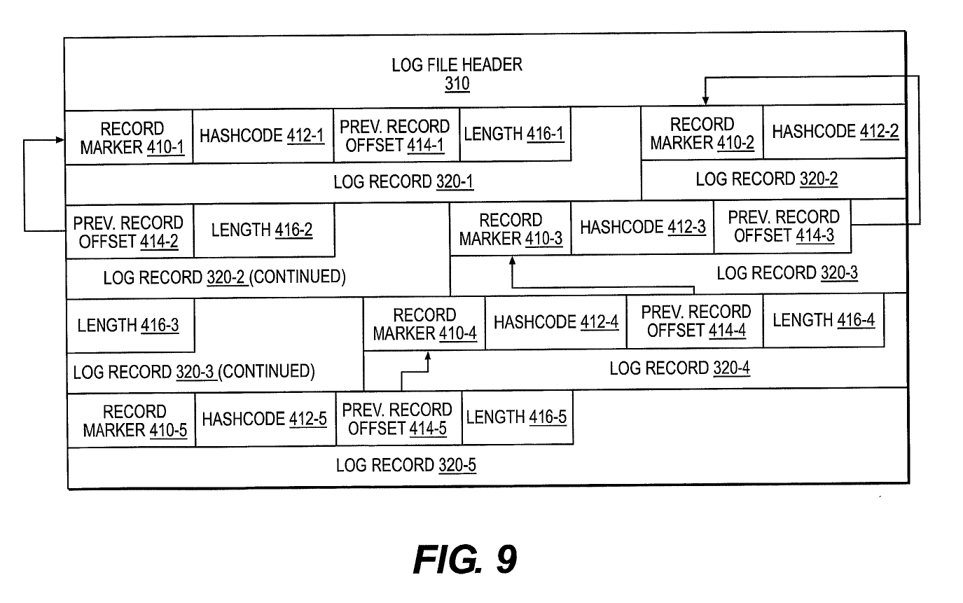

To better illustrate the use of the previous record offset field 414, FIG. 9 shows an exemplary block diagram of a log file with five log records 320-1 to 320-5. As shown, the previous record offset field 414-1 to 414-5 for log records 320-1 to 320-5, respectively, point to a record marker 410 of the next previous log record (depicted by the black arrows). Accordingly, logging service 141 may save processing time and resources by using field 414 to directly access a previous log record.

Methods and systems consistent with features of the present invention may also be modified to include a previous offset field that points to the next two or more log records. Thus, a reverse traversal to a log record that is located “N” positions previous to an accessed log record, where “N” may be a positive integer greater than 0. Also, a series of previous offset fields may be incorporated in a log record that includes a single previous offset value, a double previous offset value, triple previous offset value, etc. to allow logging service 141 to selectively access log records in log file 145. Thus, a system administrator, for example, may implement various log record configurations based on the tradeoff of the versatility of including additional previous offset fields with the added memory locations needed for log record to accommodate these new fields. It should be noted, however, that logging service 141 is not limited to using the previous record offset field 414 to locate the next previous log record in log file 145. Logging service 141 may incorporate other techniques, such as using the record ID 418 to directly access the next log record in the request (in reverse order), without departing from the scope of the invention.

Returning to FIG. 8, once the next previous log record is accessed (Step 835), logging service 141 may determine whether this accessed log record is the first log record included in the requested range of log records (Step 840). Logging service 141 may determine the location of the accessed log record by comparing the log record ID of the newly accessed log record with the first log record ID in the request from client 110. Other techniques may be employed by logging service 141 to determine whether the range of log records has been completed accessed, and methods and systems consistent with features of the present invention are not limited to the above example. If the accessed next previous log record is not the first log record associated with the request (Step 840; NO), the reverse traversal process repeats at Step 830. On the other hand, if logging service 141 accessed every log record included in the requested range of log records (Step 840; YES), a list of the log records may be generated and sent to client 110 (Step 850).

Returning to Step 815, logging service 141 may decide to traverse log file 145 using a forward traversal process (Step 855). In one configuration consistent with certain principles related to the present invention, a forward traversal may begin by accessing the first log record indicated in the requested range of log records using it's record ID, in a manner similar to that described for Step 825 (i.e., using the file pointer feature of log file 145) (Step 865). Once accessed, the hashcode 412 associated with the first log record may be verified in a manner similar to that described for Step 830 (Step 870), and stored in a results file, as previously described for the process following Step 830.

Once verified, logging service 141 may access the next log record in log file 145 following the first log record (Step 870). Logging service 141 may locate the next log record using a number of different techniques, including, but not limited to, using record length field 416 to jump to the end of the first log record. Next, logging service 141 may determine whether the next accessed log record is the last record in the range of requested log record by, for example, comparing their log record IDs (Step 875). If the requested range of log records has not been fully traversed (Step 875; NO), the forward traversal process may repeat at Step 865. On the other hand, if the requested range of log records has been fully traversed (Step 875; YES), logging service 141 may access the results file and provide the log records included therein to client 110 (Step 880).

As described, methods, systems, and articles of manufacture consistent with features of the present invention, enable server 140 to provide a requested list of log records to client 110 without having to send the entire log file over network 140. In addition to a range of log records, logging service 141 may also be configured to allow client 110 to request a single log record.

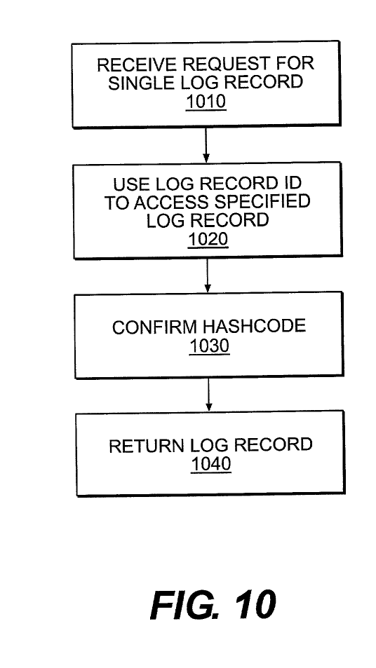

FIG. 10 illustrates an exemplary process that may be performed by logging service 141 and API 147 when a single log record 141 is requested by client 110. As shown, logging service 141 may receive a request for a single log record in log file 145 that includes a log record ID field 418 and hashcode 412 (Step 1010). Once received, logging service 141 may locate and access the requested log record using the log record ID 418, which corresponds to a file pointer used by log file 145 (Step 1020). Accordingly, the position of the requested log record may be determined virtually immediately by logging service 141. Once accessed, the log record may be validated by comparing the hashcode field 412 in the accessed log record with the hashcode provided in the requested from client 110 (Step 1030). Also, the position of the hashcode may be confirmed as well (i.e., following a record marker 410). If the two hashcodes match, (and/or the position of the hashcode within the log record is proper) logging service 141 may provide the accessed log record to client 110 (Step 1040).

As described, methods, systems, and articles of manufacture consistent with features of the present invention enable a computing system to provide efficient and versatile log record traversals. Although the configuration of the systems and methods described above allow the present invention to perform the processes described in FIGS. 5-10, variations of the methods and systems consistent with features of the present invention previously described may be implemented without departing from the scope of the invention. For example, methods, systems, and articles of manufacture, consistent with features of the present invention may be implemented using various network models, and is not limited to a CIM environment. Furthermore, methods, systems, and articles of manufacture, consistent with features of the present invention are not limited to the implementation of compliant systems and processes compliant with object oriented programming languages, such as the Java programming language. Any number of programming languages may be utilized without departing from the scope of the present invention. Additionally, the configuration of log file 145 and log records 320-1 to 320-12 are not limited to that shown in FIGS. 3 and 4. Other configurations, including additional fields, their location, and the information stored within each field, may be implemented by methods and systems consistent with features of the present invention without departing from the scope of the invention.

Also, methods and systems consistent with features of the present invention may provide services to ensure the validity of the information included within a log record. For example, logging service 141 may perform consistency checks during any of the processes shown in FIGS. 3-10, as well as prior to or after such processes are performed. The consistency checks performed by logging service 141 may include using the record length field 416 of a log record to determine whether a record marker exists at the end of the log record. Another check that may be performed by logging service 141 is using a previous record offset field 414 to determine whether a record marker 410 exists in a previous log record in log file 145 (assuming that the previous record offset field 414 is defined to point to a record marker field 410). Furthermore, logging service 141 may determine whether appropriate values are defined in severity field 422 and category field 424. Also, the server ID field 430 may be checked to ensure it matches the server identifier associated with the server hosting log file 145. Another consistency check that may be performed by logging service 141 is the verification of hashcode field 412 by recalculating the hashcode of a log record and comparing it to the hashcode field 412. Methods and systems consistent with features of the present invention may perform consistency checks while processing log record requests, or alternatively, periodically while log file 145 is not being accessed. Additionally, logging service 141 may perform consistency checks using known error checking and encoding techniques.

Other variations of the processes performed by methods and systems consistent with features of the present invention may be implemented, such as performing hashcode checks during any log record access performed by logging service 141. That is, logging service 141 may be configured to check the hashcode of a requested log record while processing any type of request provided by client 110 (or any other requesting entity). Additionally, the manner by which log records are traversed are not limited to the examples and processes shown in FIGS. 5-10 and described above. For instance, logging service 141 may be configured to use the last record offset field 312 in Step 740 of FIG. 7 to locate the last log record in log file 145. Also, Step 770 of FIG. 7 may be altered to allow logging service 141 to use the previous record offset field 414 to locate a previous log record neighboring the accessed log record, in a manner similar to that described for Step 835 in FIG. 8.

Also, methods and systems consistent with features of the present invention may be configured to allow the logging service to issue notifications to a requesting entity when a log file cannot be accessed. For example, if a request for a log record cannot be processed by the logging service for some reason (i.e., memory failure, incompatible log file version, etc.), a notification may be sent back to the requesting entity to indicate the failed log record access.

Additionally, although configurations of the present invention are described as being associated with data stored in memory and other storage mediums, one skilled in the art will appreciate that these configurations can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described configurations of the invention, but instead is defined by the appended claims in light of their full scope of equivalents.

What is claimed is:

1. A method for processing log record requests, comprising:
receiving a log record request including an identifier and a hashcode;
locating a log record in a log file based on the identifier;
verifying the log record based on the hashcode; and
responding to the request based on verifying the log record based on a result of the verification of the log record.

2. The method of claim 1, wherein the log record contains a record marker that is unique to the log file, wherein verifying comprises:
determining whether the hashcode is proximately located to the record marker.

3. The method of claim 1, wherein the log record contains a record marker that is unique to the log file, wherein verifying comprises:
determining whether a hashcode defined in the log record represents a function of the hashcode included in the request.

4. The method of claim 1, wherein the identifier is based on a file pointer that reflects a position of the log record within the log file.

5. The method of claim 1, wherein the request is received after providing the client with a header associated with the log record, wherein the header contains at least the hashcode and identifier.

6. The method of claim 5, wherein the log file contains one or more other log records, and wherein the request is received after providing the client with a list of headers, wherein each header contains at least an identifier and a hashcode that correspond to a respective log record located in the log file.

7. A method for processing log record requests, comprising:
(i) receiving a request for one or more log records included in a log file;
(ii) directly accessing a log record indicated in the request;
(iii) sorting the accessed log record based on the request;
(iv) directly accessing a next log record in the log file based on a field contained within the accessed log record;
(v) repeating (iii) and (iv) until each log record included in the request is sorted and accessed; and
(vi) providing a list of the sorted log records.

8. The method of claim 7, wherein the field is an offset that points to a next log record located before the accessed log record in the log file, and wherein directly accessing a next log record comprises:
reading the offset; and
moving to the beginning of the next log record using the offset.

9. The method of claim 7, wherein the field reflects the length of the accessed log record, and wherein directly accessing a next log record comprises:
determining the length of the accessed log record based on the field; and
moving to the beginning of the next log record based on the determination.

10. The method of claim 7, wherein repeating comprises:
sorting the accessed log records based on one of a timestamp, log record identifier, type of severity, type of category, user ID, and client ID.

11. The method of claim 10, wherein each log record included in the log file contains a particular field associated with one of the timestamp, log record identifier, type of severity, type of category, user ID, and client ID.

12. The method of claim 11, wherein sorting the accessed log records further comprises:
accessing the particular field; and
sorting the accessed log records based on information contained in the particular field.

13. The method of claim 7, wherein repeating comprises:
sorting the accessed log records chronologically based on a timestamp field contained within each accessed log record.

14. The method of claim 7, wherein repeating comprises:
sorting the accessed log records reverse-chronologically based on a timestamp field contained within each accessed log record.

15. The method of claim 7, wherein an offset is defined in a log file header that points to a last log record in the log file, and wherein accessing a log record comprises:
reading the offset; and
directly accessing the last log record based on the offset.

16. A method for accessing a log record contained within a log file that includes a plurality of log records, comprising:
receiving a request for a set of log records included in the log file;
directly accessing a log record included in the set of log records based on an identifier associated with the accessed log record;
directly accessing a log record adjacent to the accessed log record in the log file based on a field included in the accessed log record; and
repeating the step of accessing an adjacent log record for each accessed log record until an access attempt has been performed for each log record included in the set.

17. The method of claim 16, wherein the field includes an offset that points to a previous log record located before the accessed log record in the log file, and wherein directly accessing an adjacent log record comprises:
reading the field; and
moving to the previous log record.

18. The method of claim 17, wherein the previous log record is located immediately before the accessed log record in the log file.

19. The method of claim 16, wherein the field includes a length value that reflects the size of the accessed log record, and wherein directly accessing an adjacent log record comprises:
determining the size of the accessed log record based on the field;
moving to the adjacent log record based on the determination, wherein the adjacent log record is located immediately after the accessed log record in the log file.

20. The method of claim 16, wherein the identifier is based on a file pointer associated with the log file, and wherein directly accessing a log record included in the set of log records based on an identifier comprises:
using the identifier to determine the location of the log record in the log file; and
directly accessing the location of the log record using the identifier as a file pointer.

21. The method of claim 16, wherein repeating the step of accessing an adjacent log record for each accessed log record comprises:
determining whether the accessed adjacent log record is the last log record included in the set of log records; and
providing the accessed log records to a client when it is determined that each log record in the set has been accessed.

22. The method of claim 21, wherein the request includes an identifier and the step of determining comprises:
comparing the identifier of the accessed adjacent log record with an identifier included in the request for the set of log records.

23. The method of claim 16, wherein the step of directly accessing a log record included in the set of log records comprises:
verifying the accessed log record using a hashcode associated with the log record.

24. A method for processing a request for a log record, comprising:
receiving a request for a log record contained in a log file, wherein the request includes an identifier and a hashcode, each associated with the requested log record;
determining the location of the log record in the log file based on the identifier;
directly accessing the log record based on the determination;
verifying the log record using the hashcode; and
providing the log record based on the verification of the log record.

25. The method of claim 24, wherein the identifier is based on a file pointer associated with the log file.

26. The method of claim 24, wherein verifying the log record comprises:
determining whether the hashcode included in the request is located in a proper location within the log record.

27. The method of claim 26, wherein determining whether the hashcode included in the request is located in a proper location within the log record further comprises:
determining whether the hashcode included in the request is following a record marker within the log record, wherein the record marker is unique to the log file.

28. A method for creating a log record in a log file, comprising:
receiving a request to create a log record;
accessing an offset that points to a last record in the log file, wherein the offset is located in a header portion of the log file;
creating the log record based on information received in the request;
directly accessing a next available location in the log file based on the offset; and
writing the created log record in the next available location.

29. The method of claim 28, wherein creating the log record comprises:
accessing a field in the header portion that includes a unique value corresponding to the log file; and
placing the unique value in a field of the created log record.

30. The method of claim 29, wherein creating the log record further comprises:
creating a hashcode unique to the created log record; and
placing the hashcode in another field of the created log record.

31. The method of claim 28, wherein creating the log record further comprises:
determining a previous record offset that points to the last log record included in the log file; and
placing the record offset in a field of the created log record.

32. The method of claim 28, wherein creating the log record further comprises:
determining the position of a next available location in the log file following the last log record; and
creating an identifier that is unique to the log record based on the determination.

33. The method of claim 32, wherein determining the position of the next available location is based on a file pointer associated with the log file, and wherein the identifier is created using the file pointer.

34. A system for processing log record requests, comprising:
a client for generating a request including an identifier and a hashcode associated with a log record; and
a server containing a logging service for receiving the request, directly accessing the log record in a log file based on the identifier, verifying the log record using the hashcode, and providing the log record to the client based on its verification.

35. The system of claim 34, wherein the identifier is based on a file pointer that points directly to the beginning of the log record.

36. The system of claim 34, wherein the hashcode is unique to the log record and the logging service verifies the log record by confirming at least one of the location of the hashcode in the log record and the contents of the hashcode.

37. The system of claim 34, wherein the request includes a set of identifiers and hashcodes that each are associated with a corresponding log record included in the log file, and wherein the logging service is configured to:
use each identifier in the request to directly access its corresponding log record;
use each hashcode in the request to verify its corresponding log record; and
provide the accessed log records based on the verification of the log records.

38. A system for processing log record requests, comprising:
a client for generating a request for a set of log records located in a log file, wherein the request includes identifiers and hashcodes that are each associated with an individual log record included in the set; and
a logging service for:
directly accessing a log record included in the request using an identifier associated with the log record;
verifying the accessed log record using a hashcode associated with the log record;
directly accessing a next log record located near the accessed log record in the log file using a field included in the accessed log record; and
repeating the verifying and directly accessing a next log record steps until the logging service has attempted to access each log record in the set.

39. The system of claim 38, wherein the field includes an offset that points to a previous log record located immediately before the accessed log record, and the logging service is further configured to:
directly accessing the previous log record located immediately before the accessed log record using the offset.

40. The system of claim 38, wherein the field includes a length value that reflects the size of the accessed log record, and wherein the logging service is further configured to:
directly access a next log record located immediately following the accessed log record based on the length value.

41. The system of claim 38, wherein the identifier is based on a file pointer that reflects a position in the log file where the log record is located, and wherein logging service is configured to use the identifier to locate the position and access the log record.

42. The system of claim 38, wherein the logging service verifies the log record by determining one of (i) the position of the hashcode within the accessed log record, and (ii) whether the hashcode in the request matches a hashcode included within the accessed log record.

43. A method for processing log record requests, comprising:
sending a request for log records to a server;
receiving a set of log record headers, wherein each header in the set includes an identifier and a hashcode that corresponds to a log record included in a log file managed by the server;
sending a second request for a first log record to the server, wherein the second request includes the identifier and hashcode that corresponds to the first log record; and
receiving the first log record from the server.

44. A system for processing log record requests, comprising:
a processor; and
a log file including:
a data structure for maintaining a log record, wherein the log record includes at least one of:
a first location containing a marker that is unique to the log file,
a second location containing a hashcode that is unique to the log record,
a third location containing an offset to a previous log record located immediately before the log record in the log file,
a fourth location containing a record length that reflects the size of the log record, and
a fifth location containing an identifier that corresponds to a position of the log record within the log file,
wherein the processor processes a request for the log record using at least one of the first through fifth locations.

45. A system for creating a log record, comprising:
a processor; and
a memory including:
a data structure for creating a log record, comprising:
a first location containing a marker that is unique to the log file,
a second location containing an offset to a last log record included in the log file, and
a third location containing another offset to the last location of the log file,
wherein the processor accessing the first, second, and third locations to create a new log record.

46. The system of claim 45, wherein the processor accesses the first location to place the marker in the new log record alongside a hashcode that is unique to the new log record.

47. The system of claim 45, wherein the processor accesses the second location to directly access the first available location following a last log record in the log file and writes the new log record in the log file beginning at the first available location.

48. The system of claim 45, wherein the processor access the third location to verify that the new log record will fit within the log file.
